(19) United States
(12) Patent Application Publication
(10) Pub. No.: US 2022/0181676 A1
(43) Pub. Date: Jun. 9, 2022

(54) SOLID ELECTROLYTE WITH EXCELLENT ION CONDUCTIVITY

(71) Applicants: HYUNDAI MOTOR COMPANY, Seoul (KR); KIA CORPORATION, Seoul (KR); Industry-University Cooperation Foundation Hanyang University ERICA Campus, Ansan-si (KR)

(72) Inventors: In Woo Song, Gwacheon-si (KR); Ju Yeong Seong, Suwon-si (KR); Hong Seok Min, Yongin-si (KR); Yong Jun Jang, Seongnam-si (KR); Sang Heon Lee, Yongin-si (KR); Sang Uck Lee, Bucheon-si (KR); Byeong Sun Jun, Suwon-si (KR)

(21) Appl. No.: 17/380,570

(22) Filed: Jul. 20, 2021

(30) Foreign Application Priority Data
Dec. 8, 2020 (KR) 10-2020-0170491

(51) Int. Cl. H01M 10/0562

(52) U.S. Cl. CPC H01M 10/0562; H01M 2300/008

(57) ABSTRACT

An argyrodite-based solid electrolyte may contain a compound having a novel composition calculated by simulation of Ab initio molecular dynamics (AIMD). The solid electrolyte containing a compound having a novel composition that satisfies a certain range of monoatomic disorder (è) and a certain range of standard deviation (STD) of the size of the area formed as migration paths of Li metals, which are calculated by AIMD simulation, has an advantage of excellent ion conductivity due to promoted diffusion of monoatoms in the area.

### CROSS-REFERENCE TO RELATED APPLICATION

The present application claims to Korean Patent Application No. 10-2020-0170491, filed on Dec. 8, 2020, the entire contents of which is incorporated herein for all purposes by this reference.

### BACKGROUND OF THE INVENTION

### Field of the Invention

The present invention relates to an argyrodite-based solid electrolyte containing compounds having excellent ionic conductivity, wherein the ionic conductivity is calculated by simulation of Ab initio molecular dynamics (AIMD).

### Description of Related Art

Nowadays, secondary batteries are widely used in devices ranging from large devices such as vehicles and power storage systems to small devices such as mobile phones, camcorders and notebook computers.

As the field of application of secondary batteries expands, there is increasing demand for improved safety and high performance of secondary batteries. A lithium secondary battery, which is a kind of secondary battery, has advantages of having a higher energy density and a larger capacity per unit area than a nickel-manganese battery or a nickel-cadmium battery.

However, most conventional electrolytes used in lithium secondary batteries are liquid electrolytes such as organic solvents. Therefore, safety issues such as electrolyte leakage and the resulting fire hazard have been constantly raised.

Accordingly, in recent years, interest in all-solid-state batteries using solid electrolytes rather than liquid electrolytes has increased to increase the safety of lithium secondary batteries. All-solid-state batteries replace such liquid electrolytes with solid electrolytes and are thus advantageous in terms of safety because all components of batteries, such as electrodes and electrolytes, are solid. In addition, since all-solid-state batteries are known to have advantages related to battery performance, such as high energy density, high power, and long lifespan owing to the use of a Li metal or alloy as an anode material, a great deal of research has been conducted on all-solid-state batteries, in particular, solid electrolytes having an argyrodite crystal structure.

The information included in this Background of the Invention section is only for enhancement of understanding of the general background of the invention and may not be taken as an acknowledgement or any form of suggestion that this information forms the related art already known to a person skilled in the art.

### BRIEF SUMMARY

Various aspects of the present invention are directed to providing an all-solid-state electrolyte having a novel composition to satisfy an appropriate range of a monoatomic anion disorder (è), which is a main factor of ion conductivity calculated by simulation of Ab initio molecular dynamics (AIMD), and an appropriate range of a standard deviation (STD) of an area formed as a migration path of Li metal ions, realizing excellent ionic conductivity.

The objects of the present invention are not limited to those described above. Other objects of the present invention will be clearly understood from the following description and are able to be implemented by means defined in the claims and combinations thereof.

Various aspects of the present invention are directed to providing a solid electrolyte including a compound represented by Formula 1 below:

Li_{7-a-b}[(A_{1-b}/B_{b})C₄]C₁₋ₐD₁₊ₐ [Formula 1]

wherein A and B are polyatomic anions, and C and D are monoatomic anions;

A is a group 4 element, B is a group 5 element, C is a group 6 element, and D is one selected from the group consisting of F, Cl, Br, I, or mixtures thereof; and the a satisfies −1<a<1, and the b satisfies 0<b<1.

The solid electrolyte may include a monoatomic anion of at least one element selected from the group consisting of C and D in an area formed as a migration path of Li metal ions.

The monoatomic anion of C element may have a similar size to the monoatomic anion of D element.

A standard deviation (STD) of a size of the area formed as the migration path of the Li metal ions may decrease as a monoatomic anion disorder (è) increases.

As a increases, the monoatomic anion disorder (è) may increase, the standard deviation (STD) of the area size may decrease, and ionic conductivity increase.

The disorder (è) of the monoatomic anion of at least one element selected from the group consisting of C and D included in the area may be 25% or more, and the standard deviation (STD) of the area size may be less than 0.15.

Diffusion of monoatomic anions in the area may be promoted and thus ionic conductivity may be increased, when the range of the monoatomic anion disorder (è) and the range of the standard deviation (STD) of the area size are satisfied.

The solid electrolyte may include a compound represented by Formula 2 below:

Li₆₋ₐ[BC₄]C₁₋ₐD₁₊ₐ [Formula 2]

wherein B is a group 5 element, C is a group 6 element, and D is one selected from the group consisting of F, Cl, Br, I, or mixtures thereof; and the a satisfies −1<a<1.

The solid electrolyte may include a compound represented by Formula 3 below:

Li₆[B][C]₅D [Formula 3]

wherein B is a group 5 element, C is a group 6 element, and D is one selected from the group consisting of F, Cl, Br, I, or mixtures thereof.

The solid electrolyte may include at least one selected from the group consisting of Li₆PTe₅Br, Li₆SbTe₅Br, Li₆AsTe₅Br, Li₆AsSe₅Cl, Li₆SbTe₅I, Li₆NTe₅I, Li₆NSe₅Cl, Li₆PS₅F, Li₆SbSe₅Cl, Li₆PSe₅Cl, Li₆NTe₅Br, Li₆AsTe₅I, Li₆PTe₅I, Li₆NSe₅Br, Li₆PSe₅Br, Li₆PTe₅Cl, Li₆AsSe₅Br, Li₆SbSe₅Br, Li₆SbS₅Cl, Li₆NS₅Cl, Li₆AsTe₅Cl, Li₆PS₅Cl, or mixtures thereof.

The solid electrolyte may include a compound represented by Formula 4 below:

Li₇[B][C]₆ [Formula 4]

wherein B is a group 5 element and C is a group 6 element.

The solid electrolyte may include at least one selected from the group consisting of Li₇NTe₆, Li₇NO₆, Li₇AsTe₆, Li₇PSe₆, Li₇PTe₆, Li₇PS₆, Li₇NSe₆, Li₇SbS₆, Li₇AsSe₆, Li₇SbTe₆, Li₇AsS₆, Li₇SbSe₆, Li₇AsO₆, or mixtures thereof.

The solid electrolyte may include a compound represented by Formula 5 below:

Li₅[B][C]₄D₂ [Formula 5]

wherein B is a group 5 element, C is a group 6 element, and D is one selected from the group consisting of F, Cl, Br, I, or mixtures thereof.

The solid electrolyte may include at least one selected from the group consisting of Li₇PTe₄Br₂, Li₇SbTe₄Br₂, Li₇AsTe₄Br₂, Li₇AsSe₄Cl₂, Li₇SbTe₄I₂, Li₇NTe₄I₂, Li₇NSe₄Cl₂, Li₇PS₄F₂, Li₇SbSe₄Cl₂, Li₇PSe₄Cl₂, Li₇NTe₄Br₂, Li₇AsTe₄I₂, Li₇PTe₄I₂, Li₇NSe₄Br₂, Li₇PSe₄Br₂, Li₇PTe₄Cl₂, Li₇AsSe₄Br₂, Li₇SbSe₄Br₂, Li₇SbS₄Cl₂, Li₇NS₄Cl₂, Li₇AsTe₄Cl₂, Li₇PS₅Cl₂, or mixtures thereof.

The solid electrolyte may include a compound represented by Formula 6 below:

Li₇₋ₐ[AC₄]C₁₋ₐD₁₊ₐ [Formula 6]

wherein A is a group 4 element, C is a group 6 element, and D is one selected from the group consisting of F, Cl, Br, I, or mixtures thereof; and the a satisfies −1<a<1.

The solid electrolyte may include a compound represented by Formula 7 below:

Li₇[A][C]₅D [Formula 7]

wherein A is a group 4 element, C is a group 6 element, and D is one selected from the group consisting of F, Cl, Br, I, or mixtures thereof.

The solid electrolyte may include at least one selected from the group consisting of Li₇SiSe₅Cl, Li₇GeSe₅Cl, Li₇GeTe₅I, Li₇CTe₅Br, Li₇SnS₅Cl, Li₇CTe₅I, Li₇SnSe₅Br, Li₇CSe₅Cl, Li₇GeTe₅Br, Li₇GeSe₅Br, Li₇SnTe₅I, Li₇SnSe₅Cl, Li₇GeS₅Cl, Li₇SnTe₅Br, Li₇SiS₅Cl, Li₇CSe₅Br, Li₇CS₅Cl, Li₇SiSe₅Br, Li₇GeS₅Br, Li₇CTe₅Cl, or mixtures thereof.

The solid electrolyte may include a compound represented by Formula 8 below:

Li₆[A][C]₆ [Formula 8]

wherein A is a group 4 element, and C is a group 6 element.

The solid electrolyte may include at least one selected from the group consisting of, Li₈SiSe₆, Li₈CO₆, Li₈CTe₆, Li₈CS₆, Li₈SnTe₆, Li₈CSe₆, Li₈GeSe₆, Li₈SiS₆, Li₈GeS₆, Li₈GeO₆, Li₈SiO₆, Li₈SnSe₆, Li₈SnS₆, Li₈GeTe₆, or mixtures thereof.

The solid electrolyte may include a compound represented by Formula 9 below:

Li₆[A][C]₄D₂ [Formula 9]

wherein A is a group 4 element, C is a group 6 element and D is one selected from the group consisting of F, Cl, Br, I, or mixtures thereof.

The solid electrolyte may include at least one selected from the group consisting of Li₈SiSe₄Cl₂, Li₈GeSe₄Cl₂, Li₈GeTe₄I₂, Li₈CTe₄Br₂, Li₈SnS₄Cl₂, Li₈CTe₄I₂, Li₈SnSe₄Br₂, Li₈CSe₄Cl₂, Li₈GeTe₄Br₂, Li₈GeSe₄Br₂, Li₈SnTe₄I₂, Li₈SnSe₄Cl₂, Li₈GeS₄Cl₂, Li₈SnTe₄Br₂, Li₈SiS₄Cl₂, Li₈CSe₄Br₂, Li₈CS₄Cl₂, Li₈SiSe₄Br₂, Li₈GeS₄Br₂, Li₈CTe₄Cl₂, or mixtures thereof.

Other aspects and exemplary embodiments of the present invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a three-dimensional view showing Li₆PS5D, among compounds represented by Formula 3 according to various exemplary embodiments of the present invention;

FIG. 2A shows the state in which monoatomic sulfur (S) and monoatomic D are present in an area formed as a migration path of Li metal ions in an ordered state and a disordered state in Li₆PS₅D, among compounds represented by Formula 3 according to various exemplary embodiments of the present invention;

FIG. 2B shows that an area (4c) and an area (4a) formed as migration paths of Li metal ions are adjacent to each other in Li₆PS₅D among compounds represented by Formula 3 according to various exemplary embodiments of the present invention, so diffusion of Li metal ions between the area including sulfur (S) monoatomic anions and D monoatomic anions, and another area adjacent thereto may occur;

FIG. 3A is a graph showing the cell volume and ion conductivity depending on STD of a Li area size, according to Experimental Example 1 of the present invention;

FIG. 3B is a graph showing σ_{bulk} depending on a variable a according to Experimental Example 1 of the present invention;

FIG. 4 is a graph showing STD of an area size of Li₆[B][C]₅D, among compounds represented by Formula 3 according to Experimental Example 2;

FIG. 5 is a graph showing STD of an area size of Li₇[A][C]₅D, among compounds represented by Formula 7 according to Experimental Example 2;

FIG. 6 is a graph showing STD of an area size of Li₇[B][C]₆, among compounds represented by Formula 4 according to Experimental Example 3; and

FIG. 7 is a graph showing STD of an area size of Li₈[A][C]₆, among compounds represented by Formula 8 according to Experimental Example 3.

It may be understood that the appended drawings are not necessarily to scale, presenting a somewhat simplified representation of various features illustrative of the basic principles of the present invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments, it will be understood that the present description is not intended to limit the present invention(s) to those exemplary embodiments. On the contrary, the present invention(s) is/are intended to cover not only the exemplary embodiments, but also various alternatives, modifications, equivalents and other embodiments, which may be included within the spirit and scope of the present invention as defined by the appended claims.

The objects described above, as well as other objects, features and advantages, will be clearly understood from the following exemplary embodiments with reference to the appended drawings. However, the present invention is not limited to the embodiments, and may be embodied in different forms. The exemplary embodiments are suggested only to offer a thorough and complete understanding of the included context and to sufficiently inform those skilled in the art of the technical concept of the present invention.

It will be further understood that the terms “comprises” and/or “has”, when used in the present specification, specify the presence of stated features, integers, steps, operations, elements, components or combinations thereof, but do not preclude the presence or addition of one or more other features, integers, steps, operations, elements, components, or combinations thereof.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For the present reason, it should be understood that, in all cases, the term “about” should be understood to modify all numbers, figures and/or expressions. Furthermore, when numerical ranges are disclosed in the description, these ranges are continuous, and include all numbers from the minimum to the maximum, including the maximum within each range, unless otherwise defined. Furthermore, when the range refers to an integer, it includes all integers from the minimum to the maximum, including the maximum within the range, unless otherwise defined.

It should be understood that, in the specification, when a range is referred to regarding a parameter, the parameter encompasses all figures, including end points disclosed within the range. For example, the range of “5 to 10” includes figures of 5, 6, 7, 8, 9, and 10, as well as arbitrary sub-ranges, such as ranges of 6 to 10, 7 to 10, 6 to 9, and 7 to 9, and any figures, such as 5.5, 6.5, 7.5, 5.5 to 8.5 and 6.5 to 9, between appropriate integers that fall within the range. Furthermore, for example, the range of “10% to 30%” encompasses all integers that include numbers such as 10%, 11%, 12% and 13% as well as 30%, and any sub-ranges, such as ranges of 10% to 15%, 12% to 18%, or 20% to 30%, as well as any numbers, such as 10.5%, 15.5% and 25.5%, between appropriate integers that fall within the range.

The solid electrolyte according to various exemplary embodiments of the present invention includes a compound represented by Formula 1 below.

Li_{7-a-b}[(A_{1-b}/B_{b})C₄]C₁₋ₐD₁₊ₐ [Formula 1]

wherein A and B are polyatomic anions, C and D are monoatomic anions, A is a group 4 element, B is a group 5 element, C is a group 6 element, and D is one selected from the group consisting of F, Cl, Br, and I; and the a satisfies −1<a<1, and the b satisfies 0<b<1. Preferably, a monoatomic anion of at least one element selected from the group consisting of C and D may be included in the area formed as the migration path of Li metal ions. A is a group 4 element and may include at least one selected from the group consisting of carbon (C), silicon (Si), germanium (Ge), and tin (Sn). Furthermore, B is a group 5 element and may include at least one selected from the group consisting of nitrogen (N), phosphorus (P), arsenic (As), and antimony (Sb). Furthermore, C is a group 6 element and may include at least one selected from the group consisting of oxygen (O), sulfur (S), selenium (Se), and tellurium (Te).

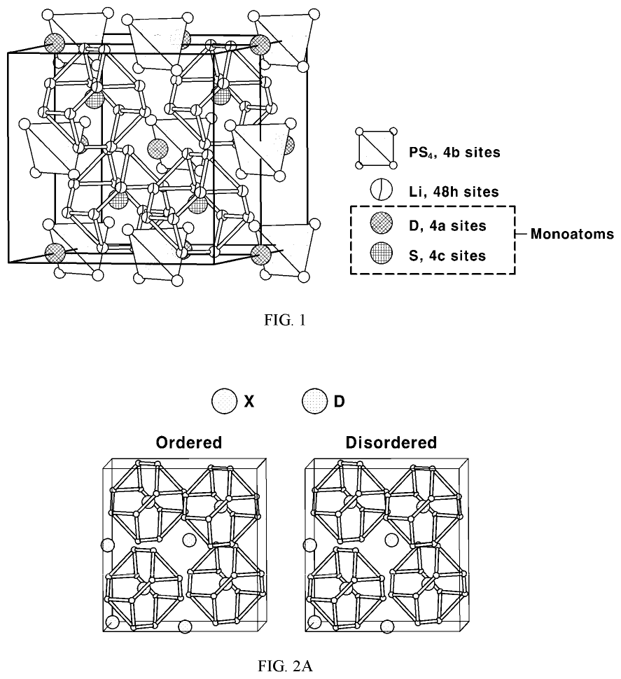

FIG. 1 is a three-dimensional view showing Li₆PS₅D among compounds represented by Formula 3 according to various exemplary embodiments of the present invention. Referring to FIG. 1, in Li₆PS₅D, PS₄ is present at the 4b area, Li is present at the 48h and 24g areas, D is present at the 4a area, and sulfur (S) of C is present at the 4c area. In the instant case, the 4a area is a lattice point of a face-centered cubic of the unit cell, the 4b area is an octahedral hole area formed at the 4a area, which is a face-centered cubic lattice, the 4c area is a tetrahedral hole area formed at the 4a area, which is a face-centered cubic lattice, and the 48h area is an area formed around the 4c area.

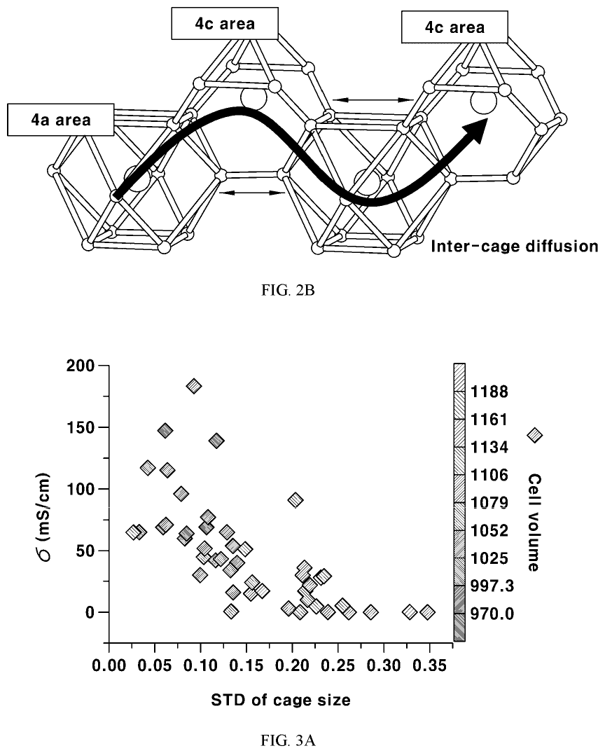

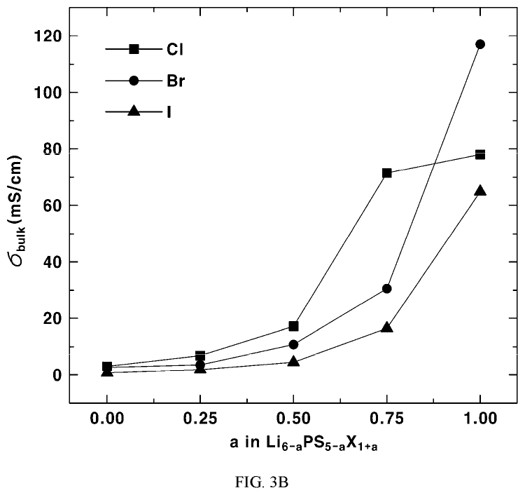

Referring to FIG. 2A, when the monoatomic sulfur (S) and D are in an ordered state, only sulfur (S) monoatomic anions exist in the area formed as the migration path of Li metal ions, but when the monoatomic sulfur (S) and D are in an ordered state, D monoatomic anions as well as the sulfur (S) monoatomic anions exist therein.

That is, referring to FIG. 2B, in a disordered state, areas 4c and 4a, which are areas formed as migration paths of Li metals, are adjacent to each other, and the areas include sulfur (S) monoatomic anions and D monoatomic anions. Thus, in the solid electrolyte according to various exemplary embodiments of the present invention, monoatomic anions of at least one element selected from the group consisting of C and D may be included in areas formed as migration paths of Li metal ions, and diffusion of Li metal ions may occur between the areas including the monoatomic anions.

In the instant case, as a result of intensive research to find factors that can improve ionic conductivity, the present inventors found that, when the disorder (è) of monoatomic anions included in the areas (4a and 4c) formed as migration paths of Li metal ions is 25% or more, and the standard deviation (STD) of the size of the area including Li metal ions is less than 0.15, the diffusion of Li metal ions between areas having a similar size formed around the monoatomic anion C element and the monoatomic anion D element is facilitated, so that the ionic conductivity increases. Based on the present finding, the present invention was completed.

The ab initio molecular dynamics (AIMD) simulation according to various exemplary embodiments of the present invention is a simulation in which density functional theory (DFT) is combined with molecular dynamics (MD). Density functional theory is one theory for calculating the shape and energy of electrons located inside a substance or molecule using quantum mechanics, and molecular dynamics (MD) is a method for analyzing the static and dynamic stable structures and dynamics of a system by solving a Newtonian equation of classical mechanics theory at a predetermined potential between two or more atoms.

Preferably, through the simulation of Ab initio molecular dynamics (AIMD) using a combination of DFT and MD according to various exemplary embodiments of the present invention, the standard deviation (STD) of the size of the area formed as the migration path of the Li metal and the monoatomic disorder (è) may be calculated, and thus ionic conductivity may be calculated.

The method of obtaining the monoatomic disorder (è) may be performed in consideration of the anion disorder in a target compound by modeling the crystal structure of the target compound. That is, the crystal structure of the target compound may be modeled through symmetry-adapted-cluster expansion.

That is, when there is one type of monoatom (a=1 in Formula 1 Li_{7-a-b}[(A_{1-b}/B_{b})C₄]C₁₋ₐD₁₊ₐ, the composition satisfies Formula 4 and Formula 8), the monoatomic disorder always satisfies 0% because the same monoatoms fill 4a and 4c areas. In the other case, when there are two or more types of monoatoms, the anion disorder in the target compound may be designed by modeling a crystal structure reflecting the number of cases where two different types of monoatoms can fill the 4a area and the 4c [ ]area through the modeling structure. As a result, the degree of disorder is determined by calculating the number of each type of monoatoms filling the 4a area (four 4a areas are present in the crystal structure) and the number of each type of monoatoms filling the 4c [ ]area (four 4c areas are present in the crystal structure) as a percentage.

As such, an energetically optimized structure at OK is obtained as an initial structure for performing AIMD simulation depending on the temperature of all crystal structures in consideration of the degree of disorder.

As such, all of the optimized crystal structures may be subjected to AIMD simulations at 600K, 800K, 1000K, and 1200K. That is, the simulation may be performed four times at each temperature until a relative standard deviation (RSD) that satisfies Equation 1 below is less than 0.25 while performing a simulation with a minimum time of 100 ps (Ensemble average). The RSD is a measure for determining the reliability of simulation calculation, and it may be seen that as the value of RSD decreases, the accuracy of calculation increases. That is, as the simulation time increases, the accuracy of calculation increases. However, RSD is a parameter for determining a reliable simulation time for an efficient calculation time. When the RSD is empirically observed to be less than 0.25, the reliability and simulation efficiency are the best. For the Li area size, after heating above a specific temperature (300K) using AIMD simulation, the distance between the monoatoms and the lithium ions around the monoatoms located at the 4a and 4c areas is calculated, and then the average value is calculated.

$$RSD = \frac{{S}_{D}}{{D}_{true}} = \frac{3.43}{\sqrt{{N}_{eff}}} + 0.04 \qquad [ Equation 1 ]$$

RSD: Relative standard deviation

S_{D}: Standard deviation of short simulation

Dₜᵣᵤₑ: Calculated diffusivity from longest available MD simulation

N_{eff}: Effective number of ion hops of all mobile ions

The standard deviation of the size of the Li area is calculated as the standard deviation of the size of the Li area (r_{4a-cage}, r_{4c-cage}) calculated based on the 4a and 4c areas using the above method.

$${r}_{cage} = \frac{{\sum }_{i}^{n} {d}_{a - {Li}_{i}}}{n}$$

dₐ: Distance between free anion and Liᵢ

n: The number of Li-ions in the cage

As such, the means square displacement (MSD) may be extracted by analyzing the trajectory of the AIMD simulation obtained above. This aims at calculating preliminary ion conductivity using the MSD extraction value and the Einstein diffusion equation. Specifically, the trajectory of the AIMD simulation can be analyzed by extracting the positions of ions per unit time of the simulation, the MSD can be calculated in accordance with Equation 3 below, and the diffusivity (D) can be calculated in accordance with Equation 4.

$$\begin{matrix}MSD = 〈 {[ r ( t ) ]}^{2} 〉 = \frac{1}{N} {\sum }_{i}^{ } 〈 {[ {r}_{i} ( t + {t}_{0} ) ]}^{2} - {[ {r}_{i} ( {t}_{0} ) ]}^{2} 〉 \\ {r}_{i} \text{:} The position of mobile ion i \\ t \text{:} Time & [ Equation 3 ] \\ {D}_{T} = \frac{1}{2 d t} MSD \\ t \text{:} Time & [ Equation 4 ]\end{matrix}$$

Then, the preliminary ion conductivity can be used to infer diffusivity at 300K by Arrhenius fitting. Specifically, since ion diffusivity in a solid without a phase transition satisfies the Arrhenius correlation (Equation 5), the diffusivity at 300K can be inferred by Arrhenius fitting the diffusivity obtained by simulating a high temperature (typically 600K 1200K). By applying the diffusivity at 300 K, obtained by performing fitting to the Einstein diffusion equation (Equation 6), the ionic conductivity at 300K can be finally calculated. In Equation 6, P is a density of the diffusion ions in the unit cell, Z is a charge of the diffusion ions, F is a Faraday constant, and R is a gas constant.

$$\begin{matrix} D = {D}_{0} exp ( - \frac{{E}_{a}}{kT} ) \\ {D}_{0} \text{:} Diffusivity at infinite temperature \\ k \text{:} Boltzmann constant \\ T \text{:} Temperature & [ Equation 5 ] \\ {σ}_{300 K} = \frac{ρ {z}^{2} {F}^{2}}{RT} {D}_{300 K} \\ ρ \text{:} Molar density of mobile ions in the unit cell \\ z \text{:} Charge of mobile ions \\ F \text{:} Faraday ’ s constant \\ R \text{:} Gas temperature \\ T \text{:} Temperature & [ Equation 6 ]\end{matrix}$$

That is, the monoatomic anion disorder (è) and the standard deviation (STD) of the size of the area formed as the migration path of the Li metal ions are calculated using the above method and the ionic conductivity is calculated therefrom. The result shows that it is possible to a solid electrolyte containing a compound having a composition wherein, in the case where the standard deviation (STD) of the size of the area formed as the migration path of the Li metal ions is less than 0.15, the diffusion of Li metal ions between the areas formed around the monoatomic anions increases, resulting in higher ionic conductivity and as the monoatomic anion disorder (è) increases, ionic conductivity is further increased.

The solid electrolyte according to various exemplary embodiments of the present invention that satisfies the range of monoatomic anion disorder (è) and the standard deviation (STD) of the size of the area formed as the migration path of the Li metal ions may include a compound represented by Formula 1 below.

Li_{7-a-b}[(A_{1-b}/B_{b})C₄]C₁₋ₐD₁₊ₐ [Formula 1]

Preferably, when b is 0, the solid electrolyte may include a compound represented by the following Formula 2, and when b is 1, the solid electrolyte may include a compound represented by the following Formula 6.

Li₆₋ₐ[BC₄]C₁₋ₐD₁₊ₐ [Formula 2]

Li₇₋ₐ[AC₄]C₁₋ₐD₁₊ₐ [Formula 6]

In the instant case, in Formula 2 or Formula 6, A is a group 4 element, C is a group 6 element, and D is one selected from the group consisting of F, Cl, Br, and I; and a satisfies −1<a<1. Hereinafter, the requirements of A to D and the requirements of a may be the same as in Formulas 3 to 5 and Formulas 7 to 9.

More preferably, when b is 0, in the case where a is 0, the solid electrolyte may include a compound represented by the following Formula 3.

Li₆[B][C]₅D [Formula 3]

Even more preferably, the solid electrolyte may include at least one selected from the group consisting of Li₆PTe₅Br, Li₆SbTe₅Br, Li₆AsTe₅Br, Li₆AsSe₅Cl, Li₆SbTe₅I, Li₆NTe₅I, Li₆NSe₅Cl, Li₆PS₅F, Li₆SbSe₅Cl, Li₆PSe₅Cl, Li₆NTe₅Br, Li₆AsTe₅I, Li₆PTe₅I, Li₆NSe₅Br, Li₆PSe₅Br, Li₆PTe₅Cl, Li₆AsSe₅Br, Li₆SbSe₅Br, Li₆SbS₅Cl, Li₆NS₅Cl, Li₆AsTe₅Cl and Li₆PS₅Cl.

In addition, when b is 0, in the case where a is −1, the solid electrolyte may include a compound represented by the following Formula 4.

Li₇[B][C]₆ [Formula 4]

Even more preferably, the solid electrolyte may include at least one selected from the group consisting of Li₇NTe₆, Li₇NO₆, Li₇AsTe₆, Li₇PSe₆, Li₇PTe₆, Li₇PS₆, Li₇NSe₆, Li₇SbS₆, Li₇AsSe₆, Li₇SbTe₆, Li₇AsS₆, Li₇SbSe₆ and Li₇AsO₆.

In addition, when b is 0, in the case where a is 1, the solid electrolyte may include a compound represented by the following Formula 5.

Li₅[B][C]₄D₂ [Formula 5]

Even more preferably, the solid electrolyte may include at least one selected from the group consisting of Li₇PTe₄Br₂, Li₇SbTe₄Br₂, Li₇AsTe₄Br₂, Li₇AsSe₄Cl₂, Li₇SbTe₄I₂, Li₇NTe₄I₂, Li₇NSe₄Cl₂, Li₇PS₄F₂, Li₇SbSe₄Cl₂, Li₇PSe₄Cl₂, Li₇NTe₄Br₂, Li₇AsTe₄I₂, Li₇PTe₄I₂, Li₇NSe₄Br₂, Li₇PSe₄Br₂, Li₇PTe₄Cl₂, Li₇AsSe₄Br₂, Li₇SbSe₄Br₂, Li₇SbS₄Cl₂, Li₇NS₄Cl₂, Li₇AsTe₄Cl₂ and Li₇PS₅Cl₂.

In addition, when b is 1, in the case where a is 0, the solid electrolyte may include a compound represented by the following Formula 7.

Li₇[A][C]₅D [Formula 7]

Even more preferably, the solid electrolyte may include at least one selected from the group consisting of Li₇SiSe₅Cl, Li₇GeSe₅Cl, Li₇GeTe₅I, Li₇CTe₅Br, Li₇SnS₅Cl, Li₇CTe₅I, Li₇SnSe₅Br, Li₇CSe₅Cl, Li₇GeTe₅Br, Li₇GeSe₅Br, Li₇SnTe₅I, Li₇SnSe₅Cl, Li₇GeS₅Cl, Li₇SnTe₅Br, Li₇SiS₅Cl, Li₇CSe₅Br, Li₇CS₅Cl, Li₇SiSe₅Br, Li₇GeS₅Br and Li₇CTe₅Cl.

In addition, when b is 1, in the case where a is −1, the solid electrolyte may include a compound represented by the following Formula 8.

Li₆[A][C]₆ [Formula 8]

Even more preferably, the solid electrolyte may include at least one selected from the group consisting of, Li₈SiSe₆, Li₈CO₆, Li₈CTe₆, Li₈CS₆, Li₈SnTe₆, Li₈CSe₆, Li₈GeSe₆, Li₈SiS₆, Li₈GeS₆, Li₈GeO₆, Li₈SiO₆, Li₈SnSe₆, Li₈SnS₆ and Li₈GeTe₆.

In addition, when b is 1, in the case where a is 1, the solid electrolyte may include a compound represented by the following Formula 9.

Li₆[A][C]₄D₂ [Formula 9]

Even more preferably, the solid electrolyte may include at least one selected from the group consisting of Li₈SiSe₄Cl₂, Li₈GeSe₄Cl₂, Li₈GeTe₄I₂, Li₈CTe₄Br₂, Li₈SnS₄Cl₂, Li₈CTe₄I₂, Li₈SnSe₄Br₂, Li₈CSe₄Cl₂, Li₈GeTe₄Br₂, Li₈GeSe₄Br₂, Li₈SnTe₄I₂, Li₈SnSe₄Cl₂, Li₈GeS₄Cl₂, Li₈SnTe₄Br₂, LiSSiS₄Cl₂, LiSCSe₄Br₂, LiSCS₄Cl₂, Li₈SiSe₄Br₂, Li₈GeS₄Br₂ and Li₈CTe₄Cl₂.

The compound having the above composition has an area size standard deviation (STD) of less than 0.15 and a monoatomic disorder (è) of 25% or more, so the diffusion of Li metal ions between areas formed around monoatomic anions increases. Thus, a solid electrolyte containing a compound having the above composition has an advantage of excellent ionic conductivity.

Hereinafter, the present invention will be described in more detail with reference to specific examples. However, the following examples are provided only for better understanding of the present invention, and thus should not be construed as limiting the scope of the present invention.

### Experimental Example 1: Determination of Composition Having Excellent Ionic Conductivity by Setting Size of Monoatomic Disorder Area and its Standard Deviation (STD) of Compounds, Li₆[B][C]₅D, Li₇[B][C]₆ and Li₅[B][C]₄D₂ Depending on Range of a for Formulas 3, 4 and 5 Represented by Formula 2, (Li₆₋ₐ[BC₄]C₁₋ₐD₁₊ₐ)

In Li₆₋ₐ[BC₄]C₁₋ₐD₁₊ₐ, among the compounds represented by Formula 2, wherein D is Cl, Br, or I, and the range of a is −1<a<1, monoatomic anion disorder (6), area size, STD, and ionic conductivity of each compound were calculated, and the results are shown in Table 1 below.

TABLE 1

| | | | | Monoatomic anion disorder | | | | | Li area size (anion area size) | | | | |
|---|---|---|---|---|---|---|---|---|---|---|---|---|---|
| | | | | D⁻ | S²⁻ | D⁻ | S²⁻ | | D⁻ | S²⁻ | D⁻ | S²⁻ | |
| Li₆₋ₐPS₅₋ₐD₁₊ₐ | | # of atoms | | In 4a | In 4a | In 4c | In 4c | | 4a | 4a | 4c | 4c | Ionic conductivity |
| D | a | D | S | area | area | area | area | STD | area | area | area | area | (mS/cm) σ [σₘᵢₙ, σₘₐₓ] |
| | −1 | 0 | 8 | 0% | 100% | 0% | 100% | 0.007 | | 2.63 | | 2.61 | 168.6 |
| Cl | 0 | 4 | 4 | 100% | 0% | 0% | 100% | 0.2391 | 2.90 | | | 2.42 | 0.02 [0.004, 0.07] |
| | | | | 75% | 25% | 25% | 75% | 0.1034 | 2.77 | 2.69 | 2.61 | 2.49 | 45 [35, 58] |
| | | | | 50% | 50% | 50% | 50% | 0.0638 | 2.66 | 2.65 | 2.59 | 2.50 | 115 [92, 142] |
| | | | | 50% | 50% | 50% | 50% | 0.0931 | 2.75 | 2.55 | 2.57 | 2.51 | 183 [128, 260] |
| | | | | 25% | 75% | 75% | 25% | 0.0826 | 2.59 | 2.49 | 2.69 | 2.49 | 60 [44, 81] |
| | | | | 0% | 100% | 100% | 0% | 0.1336 | | 2.46 | 2.73 | | 0.57 [0.32, 1.04] |
| | | | | σ_{bulk} | | | | | | | | | 18.79 |
| | 0.25 | 5 | 3 | 100% | 0% | 25% | 75% | 0.1551 | 2.81 | | 2.47 | 2.50 | 15 [11 20] |
| | | | | 75% | 25% | 50% | 50% | 0.1044 | 2.75 | 2.58 | 2.53 | 2.46 | 52 [37, 73] |
| | | | | 50% | 50% | 75% | 25% | 0.0592 | 2.61 | 2.53 | 2.62 | 2.47 | 69 [53, 88] |
| | | | | 25% | 75% | 100% | 0% | 0.0624 | 2.52 | 2.52 | 2.65 | | 71 [55, 91] |
| | | | | σ_{bulk} | | | | | | | | | 27.32 |
| | 0.5 | 6 | 2 | 100% | 0% | 50% | 50% | 0.1400 | 2.79 | | 2.60 | 2.45 | 40 [30, 53] |
| | | | | 75% | 25% | 75% | 25% | 0.0847 | 2.67 | 2.55 | 2.58 | 2.43 | 64 [52, 78] |
| | | | | 50% | 50% | 100% | 0% | 0.1067 | 2.64 | 2.44 | 2.68 | | 69 [55, 87] |
| | | | | σ_{bulk} | | | | | | | | | 52.11 |
| | 0.75 | 7 | 1 | 100% | 0% | 75% | 25% | 0.1174 | 2.72 | | 2.55 | 2.44 | 139 [108, 181] |
| | | | | 75% | 25% | 100% | 0% | 0.0616 | 2.54 | 2.46 | 2.61 | | 147 [103, 210] |
| | | | | σ_{bulk} | | | | | | | | | 142.89 |
| | 1 | 8 | 0 | 100% | 0% | 100% | 0% | 0.0332 | 2.63 | | 2.56 | | 78 [61, 100] |
| Br | 0 | 4 | 4 | 100% | 0% | 0% | 100% | 0.2861 | 2.98 | | | 2.41 | 0.0005 [0.0003, 0.0009] |
| | | | | 75% | 25% | 25% | 75% | 0.1356 | 2.83 | 2.73 | 2.74 | 2.47 | 16 [14, 18] |
| | | | | 50% | 50% | 50% | 50% | 0.1166 | 2.79 | 2.56 | 2.70 | 2.50 | 42 [30, 58] |
| | | | | 50% | 50% | 50% | 50% | 0.1489 | 2.86 | 2.56 | 2.81 | 2.53 | 51.2 [43, 61] |
| | | | | 25% | 75% | 75% | 25% | 0.1046 | 2.70 | 2.47 | 2.74 | 2.62 | 51.5 [39, 68] |
| | | | | 0% | 100% | 100% | 0% | 0.2089 | | 2.45 | 2.87 | | 0.08 [0.04, 0.17] |
| | | | | σ_{bulk} | | | | | | | | | 15.36 |
| | 0.25 | 5 | 3 | 100% | 0% | 25% | 75% | 0.1964 | 2.90 | | 2.63 | 2.42 | 3.0 [2.3, 4.0] |
| | | | | 75% | 25% | 50% | 50% | 0.0998 | 2.74 | 2.55 | 2.66 | 2.48 | 30 [24, 37] |
| | | | | 50% | 50% | 75% | 25% | 0.1291 | 2.81 | 2.59 | 2.75 | 2.48 | 65 [52, 82] |
| | | | | 25% | 75% | 100% | 0% | 0.1329 | 2.57 | 2.44 | 2.77 | | 34 [27, 43] |
| | | | | σ_{bulk} | | | | | | | | | 14.22 |
| | 0.5 | 6 | 2 | 100% | 0% | 50% | 50% | 0.1564 | 2.85 | | 2.65 | 2.46 | 24 [18, 32] |
| | | | | 75% | 25% | 75% | 25% | 0.1083 | 2.73 | 2.65 | 2.72 | 2.46 | 77 [57, 104] |
| | | | | 50% | 50% | 100% | 0% | 0.1224 | 2.71 | 2.48 | 2.76 | | 43 [32, 58] |
| | | | | σ_{bulk} | | | | | | | | | 32.23 |
| | 0.75 | 7 | 1 | 100% | 0% | 75% | 25% | 0.1354 | 2.77 | | 2.66 | 2.45 | 54 [45, 66] |
| | | | | 75% | 25% | 100% | 0% | 0.0790 | 2.71 | 2.53 | 2.69 | | 96 [76, 122] |
| | | | | σ_{bulk} | | | | | | | | | 61.1 |
| | 1 | 8 | 0 | 100% | 0% | 100% | 0% | 0.0428 | 2.71 | | 2.63 | | 117 [89, 154] |
| I | 0 | 4 | 4 | 100% | 0% | 0% | 100% | 0.3479 | 3.11 | | | 2.41 | 3 × 10−6 [2 × 10−7, 6 × 10−6] |
| | | | | 75% | 25% | 25% | 75% | 0.2265 | 3.11 | 2.76 | 2.82 | 2.48 | 4.8 [3.1, 7.5] |
| | | | | 50% | 50% | 50% | 50% | 0.2118 | 2.97 | 2.55 | 2.96 | 2.53 | 30 [23, 40] |
| | | | | 50% | 50% | 50% | 50% | 0.1676 | 2.93 | 2.58 | 2.93 | 2.60 | 17 [12, 23] |
| | | | | 25% | 75% | 75% | 25% | 0.2142 | 2.83 | 2.50 | 2.97 | 2.46 | 17 [12, 25] |
| | | | | 0% | 100% | 100% | 0% | 0.3285 | | 2.48 | 3.13 | | 0.001 [0.0006, 0.003] |
| | | | | σ_{bulk} | | | | | | | | | 4.14 |
| | 0.25 | 5 | 3 | 100% | 0% | 25% | 75% | 0.2618 | 3.06 | | 2.74 | 2.42 | 0.02 [0.01, 0.03] |
| | | | | 75% | 25% | 50% | 50% | 0.2193 | 2.99 | 2.58 | 2.88 | 2.44 | 22 [17, 28] |
| | | | | 50% | 50% | 75% | 25% | 0.2115 | 2.93 | 2.52 | 2.94 | 2.50 | 30 [20, 46] |
| | | | | 25% | 75% | 100% | 0% | 0.2170 | 2.68 | 2.42 | 2.95 | | 10 [8, 12] |
| | | | | σ_{bulk} | | | | | | | | | 7.76 |
| | 0.5 | 6 | 2 | 100% | 0% | 50% | 50% | 0.2550 | 3.05 | | 2.78 | 2.43 | 5.3 [4.1, 6.8] |
| | | | | 75% | 25% | 75% | 25% | 0.2314 | 3.01 | 2.58 | 2.84 | 2.41 | 28 [22, 34] |
| | | | | 50% | 50% | 100% | 0% | 0.2137 | 2.86 | 2.43 | 2.89 | | 36 [26, 49] |
| | | | | σ_{bulk} | | | | | | | | | 13.51 |
| | 0.75 | 7 | 1 | 100% | 0% | 75% | 25% | 0.2346 | 2.99 | | 2.81 | 2.42 | 29 [21, 40] |
| | | | | 75% | 25% | 100% | 0% | 0.2037 | 2.88 | 2.46 | 2.90 | | 91 [64, 127] |
| | | | | σ_{bulk} | | | | | | | | | 32.79 |
| | 1 | 8 | 0 | 100% | 0% | 100% | 0% | 0.0270 | 2.89 | | 2.83 | | 65 [55, 76] |

* Monoatomic anion disorder: this means the degree to which monoatomic anions are distributed in the 4a and 4c areas. For example, when there are four S monoatomic anions and four halogen monoatomic anions, it means how S and halogen are each distributed in the 4a and 4c areas. The degree of disorder is the highest when each of two S and two halogen monoatomic anions are distributed in the 4a and 4c areas, respectively. The degree of disorder was the lowest when all of S and halogen monoatomic anions are located only in the 4a or 4c area.
* Li area size: After heating above a specific temperature (300 K) using AIMD simulation, the distance between the monoatoms and the lithium ions around the monoatoms located at the 4a and 4c areas is measured, and an average is then calculated.
${r}_{cage} = \frac{{\sum }_{i}^{n} {d}_{a - {Li}_{i}}}{n}$ dₐ: Distance between free anion and Liᵢ
n: The number of Li-ions in the cage
* Standard deviation of Li area size: calculated as the standard deviation of the size of the Li area (r_{4a-cage}, r_{4c-cage}) calculated based on the 4a and 4c areas using the above method.
* Ionic conductivity σ [σₘᵢₙ, σₘₐₓ]: calculated by method in accordance with Equation 5.
σ_{bulk}: The ionic conductivity calculated above is the ideal ionic conductivity of a single crystal. Thus, to calculate the ionic conductivity of the actually synthesized bulk crystal structure, calibration considering both the contribution of thermodynamic phase stability and the kinetic contribution is required. The contribution of thermodynamic phase stability and the dynamic contribution are calculated using the following Boltzmann distribution equation, and the contribution of both is expressed as the product obtained by multiplying the two.
${P}_{i} ( E ) ∝ {e}^{\frac{- Δ E}{kT}} , {P}_{i} ( σ ) ∝ {e}^{\frac{- Δ σ}{kT}} , {P}_{i} = {P}_{i} ( E ) * {P}_{i} ( σ )$ Pᵢ: Probability of configuration i among all configurations
Pᵢ(E): Probability of configuration i among all configurations calculated based on total energy
Pᵢ(σ): Probability of configuration i among all configurations calculated based on ionic conductivity
ΔE: Difference of energy/atom (E) between minimum among all configurations and configuration i
Δσ: Difference of ionic conductivity (σ) between minimum among all configurations and configuration i
k: Boltzmann constant
T: Temperature
Finally, σ_{bulk} is calculated in accordance with the following equation using the thermodynamic and kinetic phase stability contribution and ion conductivity for the phases forming the corresponding composition.
${σ}_{bulk} = {\sum }_{i} {P}_{i} {σ}_{i}$ Pᵢ: Probability of configuration i among all configurations
σᵢ: Ionic conductivity of configuration i

As can be seen from Table 1, the ion conductivity increases as the monoatomic anion disorder (è) increases, and the ion conductivity decreases as the Li area size decreases. In addition, it can be seen that the ionic conductivity increases in the order of I, Br, and Cl, indicating that a compound in which the monoatomic size of element C (group 6) is similar to the monoatomic size of element (D) (group 7) has low STD and increased lithium ion conductivity. That is, summarizing the results of the analysis based on the above table, when the standard deviation (STD) of the area formed around the monoatomic anion as the migration path of the Li metal ions is less than 0.15, and the monoatomic anion disorder (è) is 25% or more, a solid electrolyte containing a compound having high ionic conductivity can be provided.

### Experimental Example 2: Evaluation of Ionic Conductivity Through Calculation of Area STD of Li₆[B][C]₅D and Li₇[A][C]₅D, Compounds Represented by Formulas 3 and 7

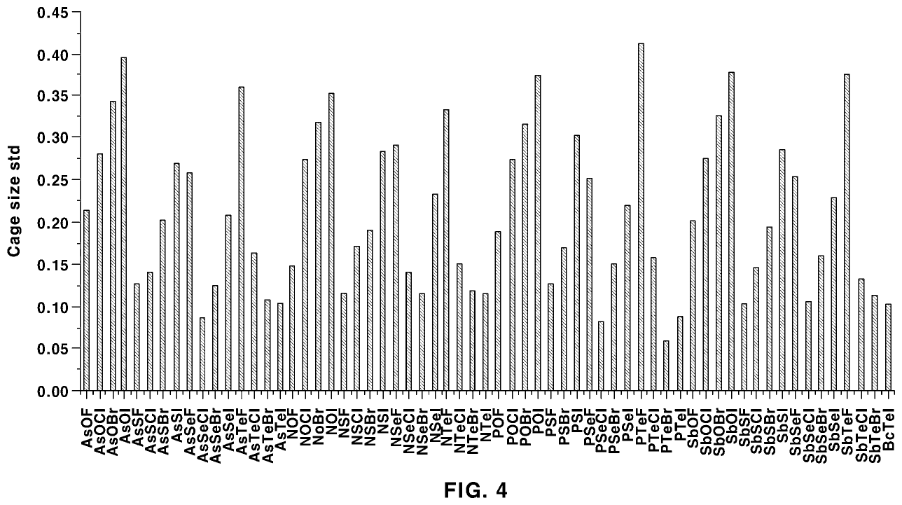

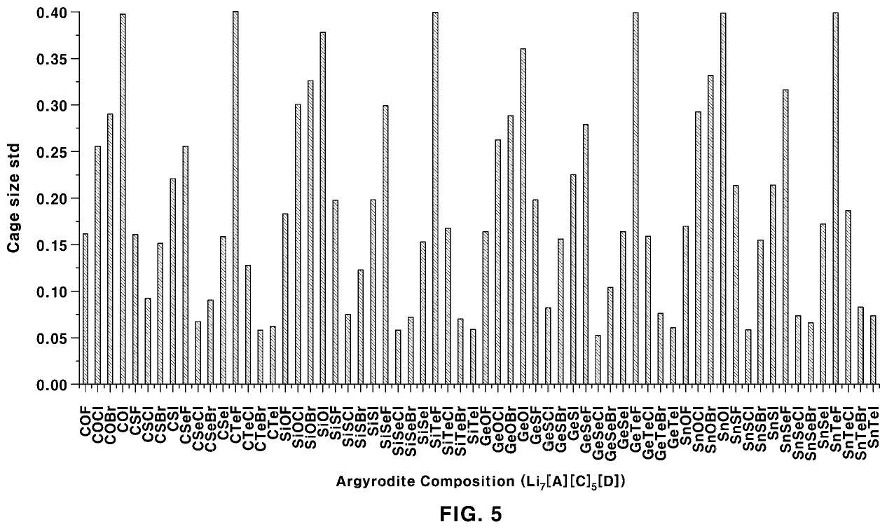

For Li₆[B][C]₅D and Li₇[A][C]₅, among the compounds represented by Formula 3 and Formula 7, the ionic conductivity was evaluated based on area size STD, and the results are shown in Table 2 below and in FIG. 4 and FIG. 5.

TABLE 2

| System | | Area size STD | Rank | σ_{bulk} |
|---|---|---|---|---|
| B—C—D | P—Te—Br | 0.0838 | 1 | 61.06 |
| in Li₆[B][C]₅D | Sb—Te—Br | 0.0871 | 2 | 24.14 |
| (Formula 3) | As—Te—Br | 0.0927 | 3 | 32.29 |
| | As—Se—Cl | 0.0950 | 4 | 17.90 |
| | Sb—Te—I | 0.1070 | 5 | 20.72 |
| | N—Te—I | 0.1087 | 6 | 13.47 |
| | Sb—Se—Cl | 0.1168 | 7 | 10.46 |
| | P—Se—Cl | 0.1177 | 8 | 31.13 |
| | N—Te—Br | 0.1189 | 9 | 22.18 |
| | As—Te—I | 0.1196 | 10 | 35.58 |
| | P—Te—I | 0.1215 | 11 | 25.04 |
| | P—Se—Br | 0.1407 | 12 | 17.28 |
| | P—Te—Cl | 0.1423 | 13 | 54.55 |
| | Sb—Se—Br | 0.1512 | 14 | 10.91 |
| A—C—D | P—S—Cl | 0.1596 | 15 | 18.8 |
| in Li₇[A][C]₅D | Si—Se—Cl | 0.0522 | 1 | 29.6 |
| (Formula 7) | Ge—Se—Cl | 0.0569 | 2 | 17.5 |
| | Ge—Te—I | 0.0572 | 3 | 14.6 |
| | Sn—S—Cl | 0.0585 | 4 | 7.6 |
| | Si—Te—I | 0.0588 | 5 | 49.9 |
| | Ge—Te—Br | 0.0684 | 6 | 47.0 |
| | Ge—Se—Br | 0.0714 | 7 | 99.8 |
| | Sn—Te—I | 0.0722 | 8 | 20.9 |
| | Si—Te—Br | 0.0744 | 9 | 74.0 |
| | Si—S—Cl | 0.0831 | 10 | 40.7 |

As can be seen from Table 2, and FIG. 4 and FIG. 5, when C is oxygen (O), the STD is great, and the effect of STD on B is not great, and the composition of an argyrodite containing C and D having a similar size has a relatively low STD. In addition, the result of AIMD evaluation of the selected STD size rank-10 compositions shows that the composition having low STD has a high calculated σ_{bulk}.

That is, the solid electrolyte containing a compound having a novel composition that satisfies the range of the monoatomic disorder (è) and the range of area size standard deviation (STD) formed by the migration path of the Li metal and calculated by AIMD simulation according to various exemplary embodiments of the present invention, has an advantage of excellent ion conductivity due to promoted diffusion of monoatoms in the area.

### Experimental Example 3: Evaluation of Ionic Conductivity Through Calculation of Area STD of Halogen-Free Li₇[B][C]₆ and Li₈[A][C]₆, Compounds Represented by Formulas 4 and 8

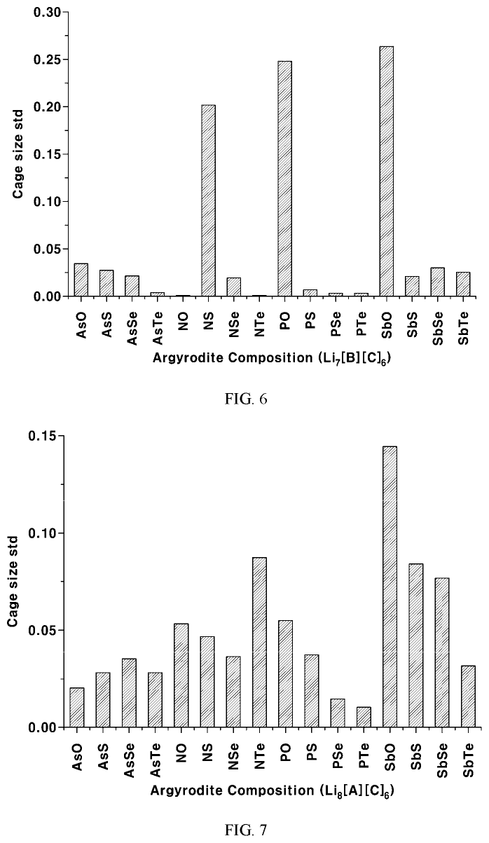

For Li₇[B][C]₆ and Li[A][C]₆, not containing halogen, which are compounds represented by Formula 4 and Formula 8, the ionic conductivity was evaluated based on the STD of the area size, and the results are shown in Table 3 below and in FIG. 6 and FIG. 7.

TABLE 3

| System | | Area size STD | Rank | σ_{bulk} |
|---|---|---|---|---|
| B—C | P—Se | 0.0117 | 1 | 9.1 |
| Li₇[B][C]₆ | P—S | 0.0174 | 2 | 168.6 |
| (Formula 4) | Sb—S | 0.0224 | 3 | 360.8 |
| | Sb—Se | 0.0340 | 4 | 31.9 |
| A—C | Si—Te | 0.0109 | 1 | 185.0 |
| in Li₈[A][C]₆ | Si—Se | 0.0146 | 2 | 188.9 |
| (Formula 8) | Sn—Te | 0.0320 | 3 | 176.1 |
| | Ge—Se | 0.0368 | 4 | 234.4 |
| | Si—S | 0.0374 | 5 | 66.7 |
| | Ge—S | 0.0463 | 6 | 66.4 |

As may be seen from Table 3 and in FIG. 6 and FIG. 7, in the case of a composition containing no halogen, the one type of anion is located in the monoatomic anion, so the area size is similar and thus the STD is very low, and as a result, a low σ_{bulk} is obtained.

### Experimental Example 4: Evaluation of Ionic Conductivity Through Calculation of Area STD of Excess Halogen-Containing Li₅[B][C]₄D₂, Compound Represented by Formula 5

For Li₅[B][C]₄D₂ containing an excess of halogen, which is a compound represented by Formula 5, ionic conductivity was evaluated based on an area size STD, and the results are shown in Table 4 below.

TABLE 4

| System | | Area size STD | Rank | σ_{bulk} |
|---|---|---|---|---|
| B—C—D | P—S—I | 0.0270 | 1 | 65 |
| in Li₅[B][C]₄D₂ | P—S—Cl | 0.0332 | 2 | 78 |
| | P—S—Br | 0.0428 | 3 | 117 |

As may be seen from Table 4, in the case of a composition containing an excessive amount of halogen, a small amount of lithium cations should be added depending on the added amount of halogen anions to maintain the overall neutral charge amount of Formula. Accordingly, the content of lithium ions in the argyrodite structure decreases, thus reducing repulsion between lithium ions and reducing the STDs of areas 4a and 4c, thereby resulting in improvement in ionic conductivity.

Apparent from the foregoing, various embodiments of the present invention relate to an argyrodite-based solid electrolyte containing a compound having a novel composition calculated by simulation of Ab initio molecular dynamics (AIMD). Specifically, the solid electrolyte containing a compound having a novel composition that satisfies the range of the monoatomic disorder (è) and the range of standard deviation (STD) of the size of the area formed as the migration path of the Li metal, which are calculated by AIMD simulation according to various exemplary embodiments of the present invention, has an advantage of excellent ion conductivity due to promoted diffusion of Li metal ions between the areas formed around monoatomic anions.

The effects of the present invention are not limited to those mentioned above. It should be understood that the effects of the present invention include all effects that may be inferred from the description of the present invention.

Although embodiments of the present invention have been described in detail, they should not be construed as limiting the scope of the present invention. Those skilled in the art will appreciate that various modifications, additions and substitutions are possible, without departing from the scope and spirit of the present invention as disclosed in the accompanying claims.

What is claimed is:

1. A solid electrolyte comprising a compound represented by Formula 1 below:
Li_{7-a-b}[(A_{1-b}/B_{b})C₄]C₁₋ₐD₁₊ₐ [Formula 1]
wherein A and B are polyatomic anions, and C and D are monoatomic anions;
A is a group 4 element, B is a group 5 element, C is a group 6 element, and D is one selected from the group consisting of F, Cl, Br, I, or mixtures thereof; and
the a satisfies −1<a<l, and the b satisfies 0<b<1.

2. The solid electrolyte according to claim 1, wherein the solid electrolyte comprises a monoatomic anion of C and D in an area formed as a migration path of Li metal ions.

3. The solid electrolyte according to claim 2, wherein a standard deviation (STD) of a size of the area formed as the migration path of the Li metal ions decreases as a monoatomic anion disorder (è) increases.

4. The solid electrolyte according to claim 2, wherein as the a increases, a monoatomic anion disorder (è) increases, a standard deviation (STD) of the area size decreases, and ionic conductivity increases.

5. The solid electrolyte according to claim 3, wherein the disorder (è) of the monoatomic anion of at least one element selected from the group consisting of C and D included in the area is equal to or greater than 25%, and
the standard deviation (STD) of the area size is less than 0.15.

6. The solid electrolyte according to claim 5, wherein diffusion of monoatomic anions in the area is promoted and thus ionic conductivity is increased, when a range of the monoatomic anion disorder (è) and a range of the standard deviation (STD) of the area size are satisfied.

7. The solid electrolyte according to claim 1, wherein the solid electrolyte comprises a compound represented by Formula 2 below:
Li₆₋ₐ[BC₄]C₁₋ₐD₁₊ₐ [Formula 2]
wherein B is a group 5 element, C is a group 6 element, and D is one selected from the group consisting of F, Cl, Br, I, or mixtures thereof, and
the a satisfies −1<a<1.

8. The solid electrolyte according to claim 7, wherein the solid electrolyte comprises a compound represented by Formula 3 below:
Li₆[B][C]₅D [Formula 3]
wherein B is a group 5 element, C is a group 6 element, and D is one selected from the group consisting of F, Cl, Br, I, or mixtures thereof.

9. The solid electrolyte according to claim 8, wherein the solid electrolyte comprises at least one selected from the group consisting of Li₆PTe₅Br, Li₆SbTe₅Br, Li₆AsTe₅Br, Li₆AsSe₅Cl, Li₆SbTe₅I, Li₆NTe₅I, Li₆NSe₅Cl, Li₆PS₅F, Li₆SbSe₅Cl, Li₆PSe₅Cl, Li₆NTe₅Br, Li₆AsTe₅I, Li₆PTe₅I, Li₆NSe₅Br, Li₆PSe₅Br, Li₆PTe₅Cl, Li₆AsSe₅Br, Li₆SbSe₅Br, Li₆SbS₅Cl, Li₆NS₅Cl, Li₆AsTe₅Cl, Li₆PS₅Cl or mixtures thereof.

10. The solid electrolyte according to claim 7, wherein the solid electrolyte comprises a compound represented by Formula 4 below:
Li₇[B][C]₆ [Formula 4]
wherein B is a group 5 element and C is a group 6 element.

11. The solid electrolyte according to claim 10, wherein the solid electrolyte comprises at least one selected from the group consisting of Li₇NTe₆, Li₇NO₆, Li₇AsTe₆, Li₇PSe₆, Li₇PTe₆, Li₇PS₆, Li₇NSe₆, Li₇SbS₆, Li₇AsSe₆, Li₇SbTe₆, Li₇AsS₆, Li₇SbSe₆, Li₇AsO₆, or mixtures thereof.

12. The solid electrolyte according to claim 7, wherein the solid electrolyte comprises a compound represented by Formula 5 below:
Li₅[B][C]₄D₂ [Formula 5]
wherein B is a group 5 element, C is a group 6 element, and D is one selected from the group consisting of F, Cl, Br, I, or mixtures thereof.

13. The solid electrolyte according to claim 12, wherein the solid electrolyte comprises at least one selected from the group consisting of Li₇PTe₄Br₂, Li₇SbTe₄Br₂, Li₇AsTe₄Br₂, Li₇AsSe₄Cl₂, Li₇SbTe₄I₂, Li₇NTe₄I₂, Li₇NSe₄Cl₂, Li₇PS₄F₂, Li₇SbSe₄Cl₂, Li₇PSe₄Cl₂, Li₇NTe₄Br₂, Li₇AsTe₄I₂, Li₇PTe₄I₂, Li₇NSe₄Br₂, Li₇PSe₄Br₂, Li₇PTe₄Cl₂, Li₇AsSe₄Br₂, Li₇SbSe₄Br₂, Li₇SbS₄Cl₂, Li₇NS₄Cl₂, Li₇AsTe₄Cl₂, Li₇PS₅Cl₂, or mixtures thereof.

14. The solid electrolyte according to claim 1, wherein the solid electrolyte comprises a compound represented by Formula 6 below:
Li₇₋ₐ[AC₄]C₁₋ₐD₁₊ₐ [Formula 6]
wherein A is a group 4 element, C is a group 6 element, and D is one selected from the group consisting of F, Cl, Br, I, or mixtures thereof, and
the a satisfies −1<a<1.

15. The solid electrolyte according to claim 14, wherein the solid electrolyte comprises a compound represented by Formula 7 below:
Li₇[A][C]₅D [Formula 7]
wherein A is a group 4 element, C is a group 6 element, and D is one selected from the group consisting of F, Cl, Br, I, or mixtures thereof.

16. The solid electrolyte according to claim 15, wherein the solid electrolyte comprises at least one selected from the group consisting of Li₇SiSe₅Cl, Li₇GeSe₅Cl, Li₇GeTe₅I, Li₇CTe₅Br, Li₇SnS₅Cl, Li₇CTe₅I, Li₇SnSe₅Br, Li₇CSe₅Cl, Li₇GeTe₅Br, Li₇GeSe₅Br, Li₇SnTe₅I, Li₇SnSe₅Cl, Li₇GeS₅Cl, Li₇SnTe₅Br, Li₇SiS₅Cl, Li₇CSe₅Br, Li₇CS₅Cl, Li₇SiSe₅Br, Li₇GeS₅Br, Li₇CTe₅Cl, or mixtures thereof.

17. The solid electrolyte according to claim 14, wherein the solid electrolyte comprises a compound represented by Formula 8 below:
Li₈[A][C]₆ [Formula 8]
wherein A is a group 4 element, and C is a group 6 element.

18. The solid electrolyte according to claim 17, wherein the solid electrolyte comprises at least one selected from the group consisting of, Li₈SiSe₆, Li₈CO₆, Li₈CTe₆, Li₈CS₆, Li₈SnTe₆, Li₈CSe₆, Li₈GeSe₆, Li₈SiS₆, Li₈GeS₆, Li₈GeO₆, Li₈SiO₆, Li₈SnSe₆, Li₈SnS₆, Li₈GeTe₆, or mixtures thereof.

19. The solid electrolyte according to claim 14, wherein the solid electrolyte comprises a compound represented by Formula 9 below:
Li₆[A][C]₄D₂ [Formula 9]
wherein A is a group 4 element, C is a group 6 element and D is one selected from the group consisting of F, Cl, Br, I, or mixtures thereof.

20. The solid electrolyte according to claim 19, wherein the solid electrolyte comprises at least one selected from the group consisting of Li₈SiSe₄Cl₂, Li₈GeSe₄Cl₂, Li₈GeTe₄I₂, Li₈CTe₄Br₂, Li₈SnS₄Cl₂, Li₈CTe₄I₂, Li₈SnSe₄Br₂, Li₈CSe₄Cl₂, Li₈GeTe₄Br₂, Li₈GeSe₄Br₂, Li₈SnTe₄I₂, Li₈SnSe₄Cl₂, Li₈GeS₄Cl₂, Li₈SnTe₄Br₂, LiSSiS₄Cl₂, LiSCSe₄Br₂, LiSCS₄Cl₂, Li₈SiSe₄Br₂, Li₈GeS₄Br₂, LiSCTe₄C₂, or mixtures thereof.
